(19) United States
(12) Patent Application Publication
(10) Pub. No.: US 2022/0227357 A1
(43) Pub. Date: Jul. 21, 2022

(54) ROAD-TRAFFIC WARNING SYSTEM FOR INCREASED USER SAFETY

(71) Applicant: Yan Aduardovich FILYAROVSKII, Moscow (RU)

(72) Inventor: Yan Aduardovich FILYAROVSKII, Moscow (RU)

(21) Appl. No.: 17/716,280

(22) Filed: Apr. 8, 2022

Related U.S. Application Data
(63) Continuation of application No. 16/639,688, filed on Feb. 17, 2020, now abandoned.

(30) Foreign Application Priority Data
Apr. 20, 2018 (RU) 2018114736

(51) Int. Cl. B60W 30/08; B60W 50/14

(52) U.S. Cl. CPC B60W 30/08; B60W 2050/146; B60W 50/14

(57) ABSTRACT

An adjustable assembly for road transport system is provided. The assembly has multiple units of which the user may select the units suitable for use with his/her bodyless vehicle, e.g. motorcycle having electronic control system of its own, or for bicycle that does not have electronic control system. Depending on the selection of units the system will either duplicate light signals of the vehicle or show alternative light signals.

### CROSS-REFERENCE TO RELATED APPLICATION

This is a continuation application of U.S. patent application Ser. No. 16/639,688, filed on Feb. 17, 2020 as a National stage application of the PCT application PCT/RU2019/000027, filed on Jan. 18, 2019 claiming priority to Russian patent application RU2018114736 filed Apr. 20, 2018, all of which fully incorporated herein by reference.

### FIELD OF INVENTION

The invention is related to an adjustable optical signalling devices, and solutions for improving traffic safety.

### SUMMARY

The technical result of the invention is to extend functionalities, increase traffic safety for users (drivers) of bodyless vehicles, provide improved visibility of bodyless vehicle users and children and workers of special services on the road, as well as to provide child, worker and user (driver) protection, prevent road traffic accidents to take place, provide markings on equipment of the user/child/worker of special services and on the vehicle to ensure an improved efficiency factor of safety measures when working in hazardous locations.

There is a need for a system which can be used to increase traffic safety of various types of users. The system disclosed here provides an assembly of elements of which the user can choose based on the type of vehicle he/she has. Elements may be chosen for a bodyless vehicle, such as motorcycle, which has its own electric control system. Elements may be chosen for a bodyless vehicle, such as a bicycle, which does not have its own electric control system. Elements may also be chosen for situation where the system is to protect a child uncapable of controlling the system him/herself. In such case the elements may be selected to be remote controlled for children's devices, or even for use in children's clothing.

Accordingly, it is an object of this invention to provide an adjustable assembly for road transport signalling system comprising: a transmitter unit, an alternative transmitter unit, a control unit, a display unit and a set of light indication elements; wherein the transmitter unit comprises a transmitter for short-range data transmission, an individual code hardware-written in a device circuit, electronic or analog filters and an electrical surge and interference protection system, and the transmitter unit is configured to be connectable with the control unit and operable at same radio frequency as the control unit; and the transmitter unit is configured to be installed in an electrical light signalling system of an bodyless vehicle; the alternative transmitter unit is a button-, voice- or touch-controlled device comprising a transmitter for short-range data transmission and a device for remote manual control, and the alternative transmitter unit is configured to be connectable with the control unit and operable at same radio frequency as the control unit; the control unit comprises a receiving device for short-range data transmission, an individual code hardware-written in a device circuit, a battery compartment, a battery charging system, an electron control device/chip, a corrector for current control, an electronic device configured for radio signal binding with a unique code outgoing from/belonging to the transmitter unit; the display unit comprises a collision sensor, a GPS tag, a display for indicating power level of control unit, and the display unit is configured to be connectable with the control unit; and the set of light indication elements is connected to the control unit and attachable to a bodyless vehicle elements, to equipment or clothing of a user of the bodyless vehicle, or to clothing of a person, and which light indication elements are controlled by the control to synchronously repeat light signals of the bodyless vehicles; wherein the units of the adjustable assembly are selectable based on the desired use, such that control unit, transmitter unit and display unit are required when the assembly is adjusted for use with bodyless vehicles that have their own electronic signalling system, control unit and alternative transmitter unit is required when the assembly is adjusted for use with bodyless vehicles that do not have their own electronic signalling system, and only control unit is required when the assembly is adjusted for children clothing or devices used by children.

According to certain aspects the system comprises a GPS tag configured to transmit an SOS signal to phone number predetermined by the user.

According to certain aspects the system comprises display unit comprising an emergency collision/rollover/fall sensor, which is configured to be triggered by a force or impact and/or by removal of a safety pin attached to a steering wheel of the bodyless vehicle and on wrist of the user; wherein triggering of the sensor causes the control unit to turn on the light indication elements to a bright SOS emergency stop signal.

According to certain aspects the system comprises control unit which is configured to turn off power in engine of the vehicle when the emergency sensor is triggered.

It is an object of this invention to provide a method of operating a road transport signalling system to enhance safety for users of bodyless vehicles, comprising: providing an adjustable assembly comprising a transmitter unit, an alternative transmitter unit, a control unit, a display unit and a set of light indication elements; wherein in case of the bodyless vehicle has its own electronic signalling system selecting the control unit, the transmitter unit and the display unit for use, and the method comprises: supplying power to an input of a transmission line consisting the transmitter unit and a receiver in the control unit when turning on an ignition of the bodyless vehicle and automatically triggering on the system, whereby a current state signal of signal lights of the bodyless vehicle is fed from an electric/electronic circuit of the bodyless vehicle and the signal is transmitted to the control unit for turning on light signalling elements, and wherein according to the incoming signals of the bodyless vehicle, the control units synchronously turns on, and off or corresponding light signaling elements of the system or changes a brightness of corresponding light elements, and wherein the light elements responsible for parking/running lights being constantly on and powered by the control unit; in case the bodyless vehicle that does not have its own electronic signalling system selecting transmitter unit and display unit for use, and wherein the alternative transmitter unit is powered by a battery and functions as a remote control for manual data transmission; and in case of devices used by children selecting only the control unit for use wherein the control unit is equipped with an electronic chip having programmed options for glowing the light indication elements and remotely control the system via a remote control connected to the control unit.

According to certain aspects the display unit comprises an emergency collision/rollover/fall sensor, and the method comprises a step of triggering the sensor by removing of a safety pin attached to a steering wheel of the bodyless vehicle and user's wrist thereby causing the control unit to turn on the light indication elements to a bright SOS emergency stop signal.

### BRIEF DESCRIPTION OF THE DRAWINGS

FIG. 1—a connection diagram

FIG. 2—a wireless connection diagram

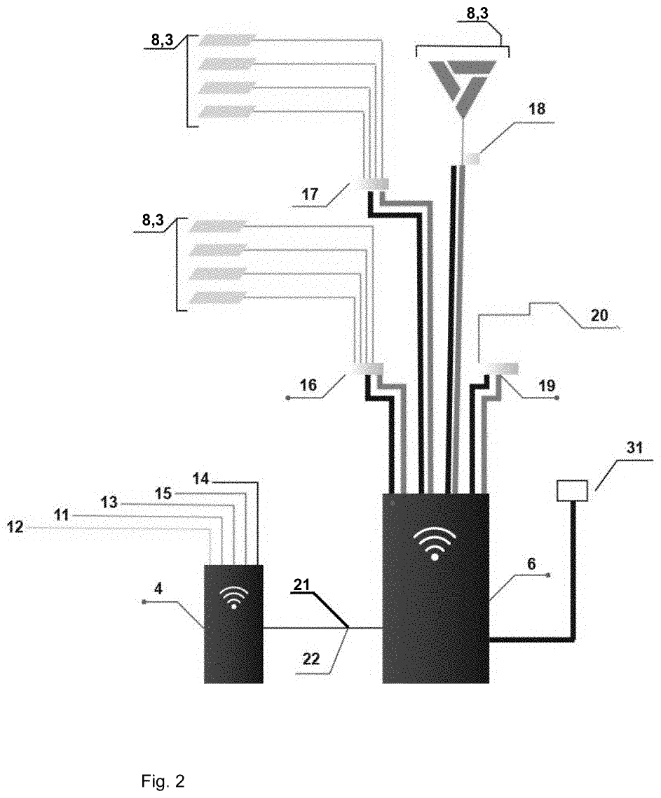

FIG. 3—a diagram fora bicycle

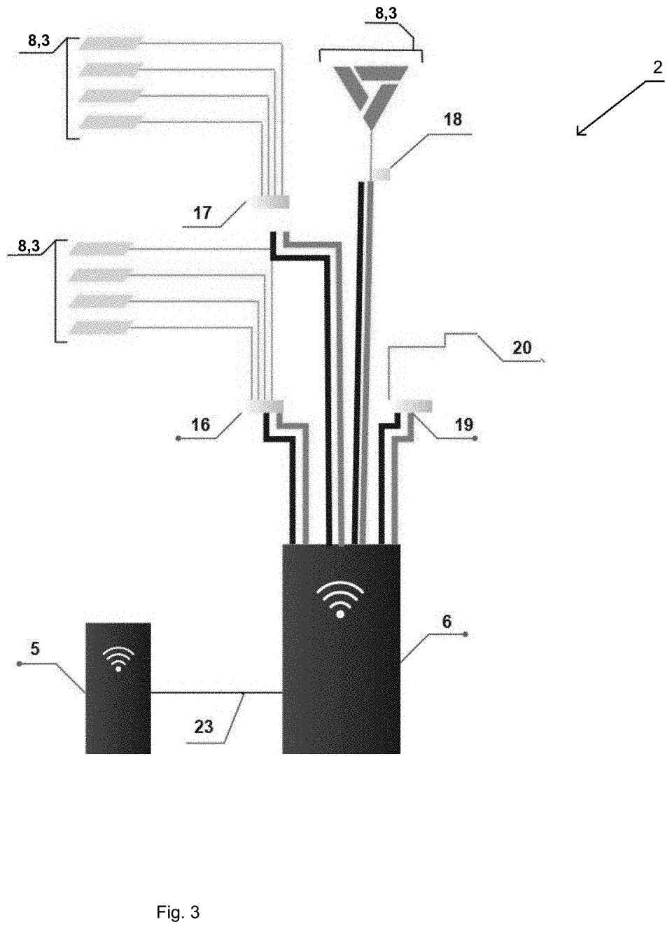

FIG. 4—a connection diagram for children and for workers of special services

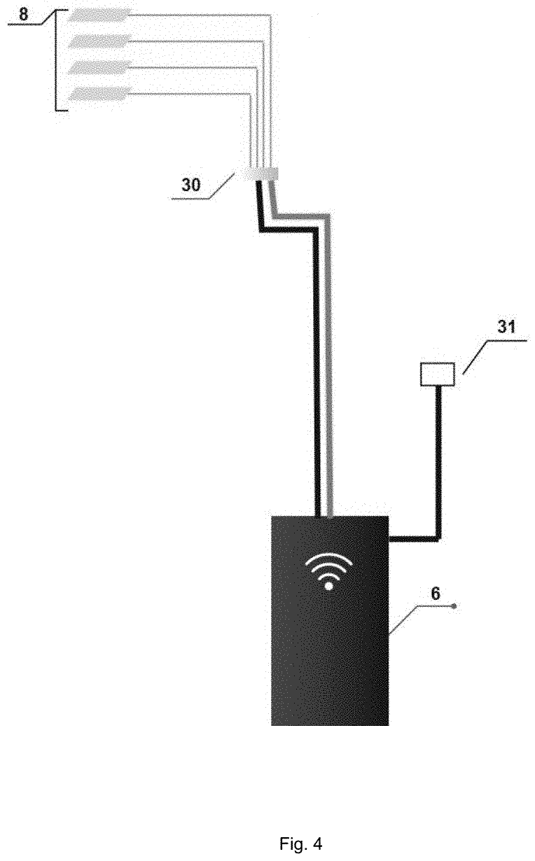

FIG. 5—a Unit 1-to-vehicle connection diagram

FIG. 6—a wired diagram for the bicycle where data is transferred via wired connection

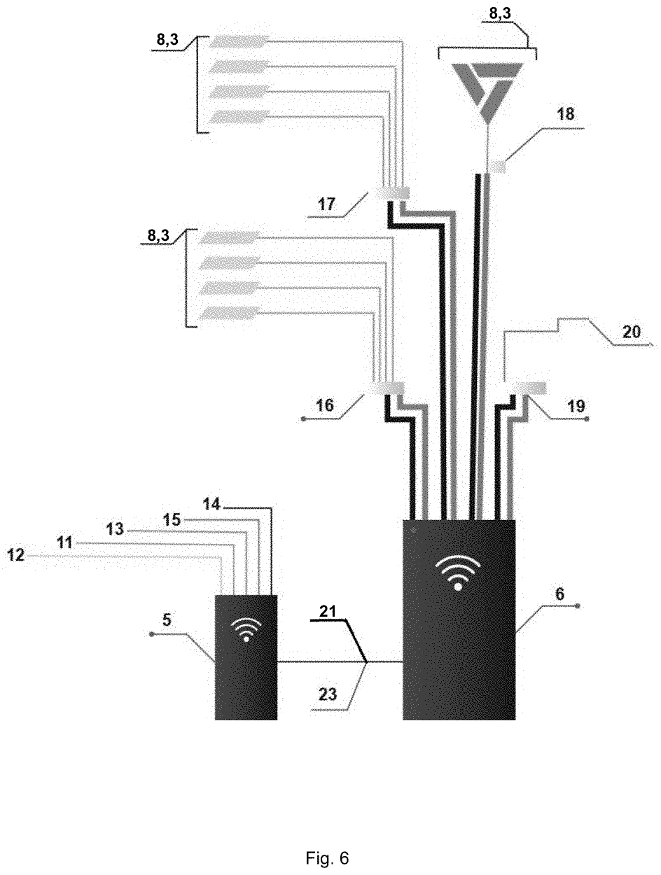

FIG. 7—a wired diagram

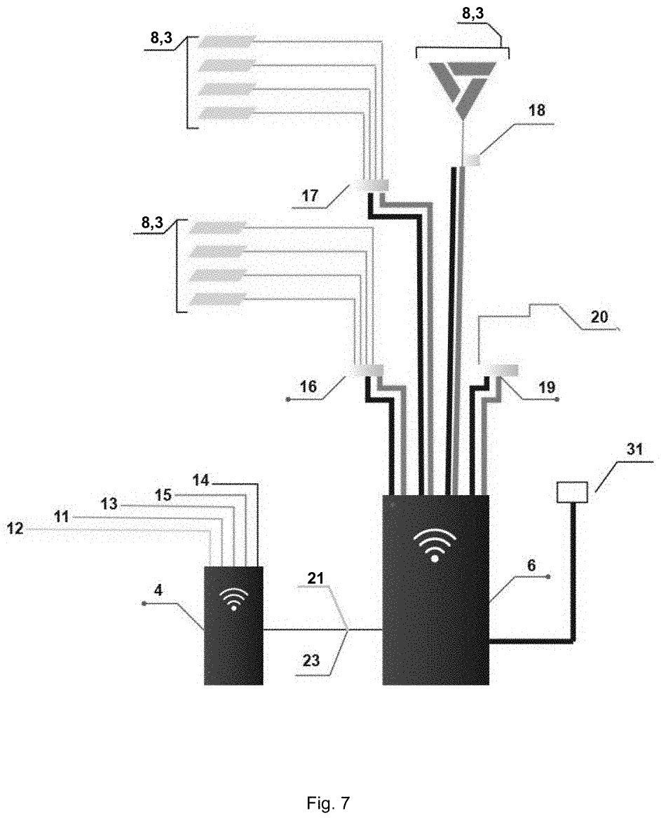

FIG. 8—a diagram with Unit 3

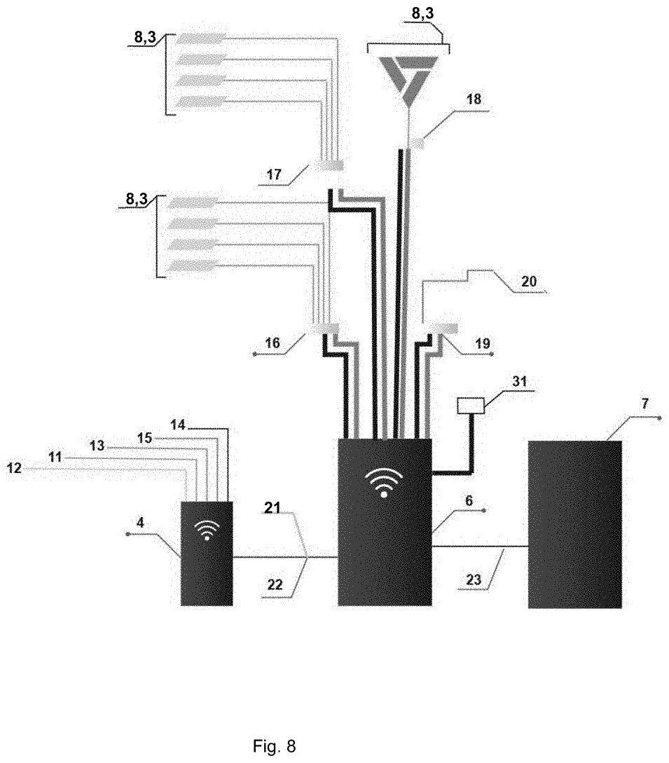

FIG. 9—a diagram with Unit 3

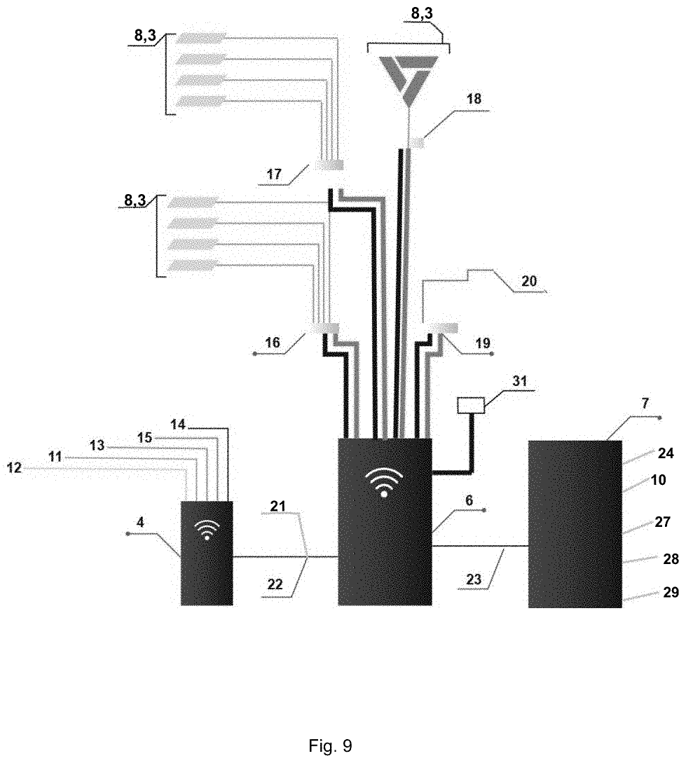

FIG. 10—shapes and types of light-emitting elements

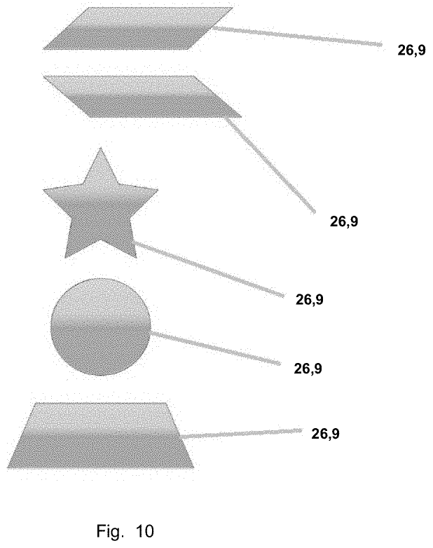

### DETAILED DESCRIPTION OF THE PREFERRED EMBODIMENT

The invention disclosed here provides system that can be easily adjusted depending on the user's needs. The system may be used in connection with such bodyless vehicles as motorcycles that have electric signaling system, as well as with such bodyless vehicles as bicycles which do not have an electric signalling or power systems, and even with moving devices used by children.

The above-posed problem is solved and the technical result is achieved by means of the disclosed road transport signaling system for enhancing safety for users of bodyless vehicles and/or vehicles that do not have conventional signaling devices. The system disclosed here includes a power and control unit (Unit 2) (6) which is required in each desired use of the system, and additionally three units: transmission unit (Unit 1) (4), alternative transmission unit (Unit 1.2) (5) and display unit (Unit 3) (7) which are chosen depending on the desired use. In addition to the units the system includes light indication elements (8), that may be duplicate signals of conventional optical signals of a vehicle. The light indication elements may be selected from left and right turn signals, stop signal, parking lights, running lights, flexible neon light. The light indication elements may be equipped with fasteners for mounting/fastening and dismounting on equipment of user or of a vehicle.

Control unit (Unit 2) (6) is configured to power and control the light indication elements. Unit 2 is also called throughout this application “control unit”. The control unit is powered by battery cells or batteries (AA, AAA, etc.), but as well its operation and/or charging from solar cell modules is also possible. The solar cell modules may be mounted anywhere where they are easily accommodated—for example, on the user's equipment, such as a backpack or a helmet. The light indication elements may be made on the basis of incandescent lamps, light emitting diodes (LEDs), light guides, neon lamps, LED matrices and matrices of light emitting devices, flexible screens, and are equipped with special fasteners for mounting/fastening and dismounting the light indication elements on equipment, clothing, helmets, backpacks, bags, motorcycle elements, a scooter, quadricycle, tricycle, motodrone/Hoversurf (flying motorcycle) and other bodyless vehicles, including waterborne vehicles, etc.

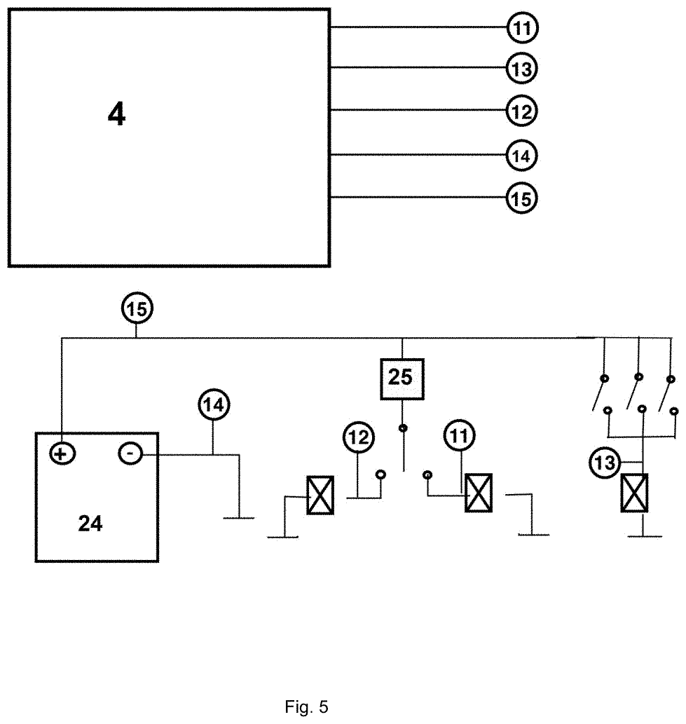

Unit 1 (transmitter unit) (4) includes a device (transmitter) for short-range data transmission via radio channels and/or other wireless signal or data transmission channels (transmitted data may be digital messages or analog signals coming from a data source, digitized into a bit stream using pulse-code modulation (PCM) or more advanced coding schemes for the data source (analog-to-digital conversion and data compression). Unit 1 is here called a ‘transmitter unit’ The transmitter unit is provided with its own individual code hardware-written in a device circuit. The data source/signal transmitter is coded and decoded by a codec/programmer or other coding means. Electronic or analog filters and electrical surge and interference protection systems are installed in the transmitter unit, since an electrical system of, for example, a motorcycle is very unstable and operates often intermittently, which is detrimental to fine-tuned devices. Electrical surge-protection systems against electrical surges and interference include voltage surge suppression and this suppression is carried out by power and signal pickup (FIG. 5 elements 24, 25) Voltage surge suppression is achieved by using voltage stabilizers (for example, stabilizer 7805) in power and signal pickup circuits and is intended for the operational stability of a wireless transmitter circuit. These circuits do not have a noticeable effect on a motorcycle circuit.

The transmitter unit is selected for use when the signalling system is used in connection with a bodyless vehicle having an electric signalling system, such as motorcycle or scooter. Transmitter unit is not selected when the system is used for bicycles or children's devices that do not have an electric signalling system. In a motorcycle the transmitter unit is installed in an electrical light signaling system of the motorcycle (usually in the electrical isolation of a tail lamp). Similarly, transmitter unit can be installed in the electrical light signalling system of a, scooter, quadricycle, tricycle and other bodyless vehicles. For waterborne and airborne vehicles, it is possible to work with a gyroscope (either built-in in the control unit or via an application on a smartphone). The transmitter unit is powered by the vehicle or its own battery or replaceable batteries.

An alternative transmitter unit (5) is used in case the bodyless vehicle is not equipped with standard light signals and a light signal supply device, for example for bicycle. The alternative transmitter unit includes a device for remote manual control (31) and short-range data transmission via radio channels and/or other wireless signal/data transmission channels (transmitted data may be digital messages or analog signals coming from a data source, digitized into a bit stream, using the pulse-code modulation (PCM) or more advanced coding schemes for the data source (the analog-to-digital conversion and data compression), and made as a button-, voice- or touch-controlled device. The alternative transmitter unit is powered by the vehicle or by its own battery or replaceable batteries.

The control unit (6) includes a receiving device for short-range data transmission via radio channels an electron control device for light elements. The control unit is provided with its own individual code hardware-written in the device circuit. The transmitter unit (4) or the alternative transmitter unit (5) is connected to control unit and they operate with each other in the same frequency range. The control unit is equipped with an electronic device for radio signal binding a unique code outgoing from/belonging to transmitter or alternative transmitter unit, thereby providing increased use and distribution of the devices and avoiding the need to contact a manufacturer to encode a certain set. The control unit is further equipped with a battery compartment; and a battery charging system. The control unit is also equipped with an electron control device/electron chip, which carries out synchronously repeating lighting up the light indication elements connected to it as well as the light signals of the bodyless vehicle. The control unit also comprises a corrector of control current for controlling neon light elements and controlling a geolocation Unit. The control unit further is also provided with a system for reducing energy consumption when multiple task run at same time; e.g. constant operation of light elements without loss during the stated operation time of the device light indication elements. This is possible due to right selection of transistors to the LEDs used in the device and by operation of a lighting sensor. With this assembly the parking lights have two brightness modes which makes it possible to reduce energy consumption. The parking lights of the device are constantly on and brighter during the day, and with natural darkening, the lighting sensor is triggered and parking lights reduce their brightness by 20-30%. When light is changed the lighting sensor turns on parking lights at 100% brightness

The GPS geolocation Unit (10) (GSM/GPRS tag or SIM card) is part of Unit 3, which is called here the display unit (7). The GPS Geolocation unit includes a beacon for tracking a user or vehicle. The GPS geolocation Unit is configured to transmit t an SOS signal to phone numbers predefined by a user, in order to automatically notify when user/vehicle is in danger. In the meantime, it is possible to track movements of the user in real time by coordinating data from a GPS sensor with maps. The control unit may be realized in different alternatives, for example the control unit can be installed in a jacket of motorcyclist.

The display unit includes a device with a display for indicating a power level of the battery of the receiving device (power unit), current time, air temperature, an operation indicator of the GPS tag. Display unit (7) is chosen for use when the system is used with bodyless vehicles such as motorcycles. A collision sensor (29) and a GSM tag (10) are mounted in the display unit. GSM tag shows where the user is and it transmits in case of an accident, the SOS signal and turns on emergency lighting on the equipment of light indication elements of signaling system. Display system is further equipped with battery/batteries and a charging system. The unit is further equipped with fasteners for mounting/fastening on and dismounting on the equipment of user and/or on the equipment of the bodyless vehicles or om a user's body. It is also possible to use a lighting sensor, which may be mounted in the display unit or installed on the equipment of the user. The lighting sensor is triggered when lighting changes and adjusts the brightness of light indication elements. When dark, the lighting sensor turns on the light indication elements representing parking lights and in bright light—turns off these light indication elements of parking lights.

The display unit is also provided with an emergency collision/rollover/fall sensor, which is triggered by a force of impact and/or by means of a safety pin, the safety pin being attached to motorcycle or bicycle handlebars and on a user wrist. When the sensor or safety pin is triggered, when user is released from vehicle, the light indication elements connected to control unit turn on/show a bright light signal a bright emergency stop light/SOS signal (for example, a strobe) to provide visibility and detection of the user. The SOS signal is transmitted via the GSM tag of the display unit, and an engine of the bodyless vehicle is configured, in case of emergency, to be shut down/turned off/cut off if the collision sensor is triggered and in case the safety pin is provided the safety pin is taken out using a safety cord.

The control unit and the display unit are also provided with a button for turning on/off the system, which is mounted on the equipment, and a set of connecting wires, adapters and mounts for mounting and dismounting the road transport signaling system on the equipment of user or on the equipment of bodyless vehicle.

When using such a bodyless vehicle as a motorcycle, the transmitter unit is a device transmitting current motorcycle signals via radio communications or by wire, is provided with a circuit for receiving/transmitting incoming signals from the motorcycle to the control unit or to the display unit of a radio receiver (receiving device for short-range data transmission over radio channels in state-authorized frequency ranges) or through a wired system.

Transmitter unit is equipped, at the output of an electronic transceiver circuit, with wires that are connected in the tail lamp compartment of the motorcycle based on a diagram (instruction) for correcting to the set of signaling system, consisting of transmitter unit, control unit light indication elements, wires for connection, connection diagram.

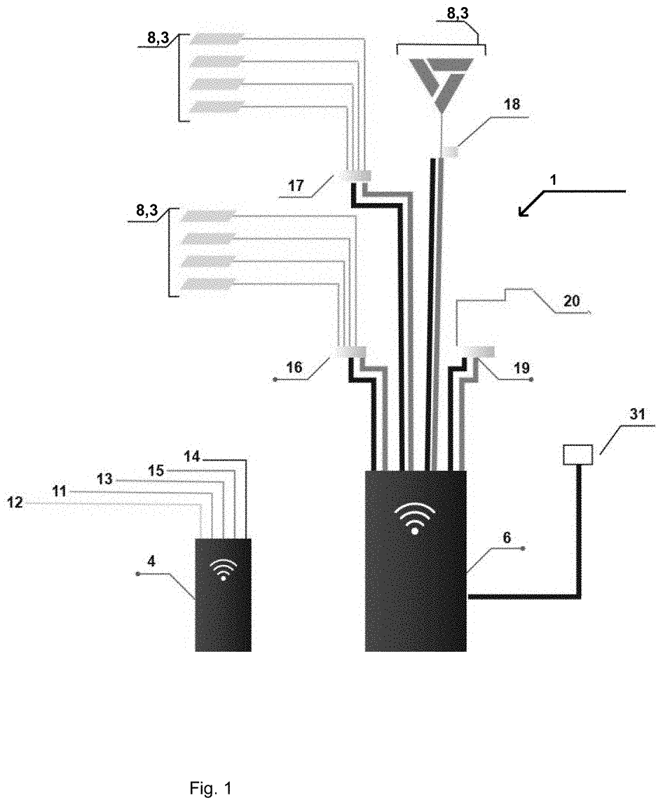

Accordingly, power is supplied to a power wire of the control unit when the motorcycle mode is on (ignition ON), to left turn and right turn signal wires, as well as to stop signal wires (see FIG. 1). Control unit may also be connected to the vehicle in any other place suitable for its mounting according to the existing circuit.

When the motorcycle ignition is in the ON position, power is supplied to the input of a transmission line (wireless, consisting of a transmitter and receiver, or wired (without a radio transmitting device)), for which reason the transmission line turns on automatically. Next, a current state signal of signal lights is fed from the motorcycle circuit, and the transmission line transmits the signal to the control device for the signal elements (Control unit), which is turned on by a remote button mounted on the equipment of user or on control unit itself or on display unit. According to the incoming motorcycle signals, the control device for the signal elements synchronously turns on, turns off, or changes the brightness of its own corresponding light signalling elements. The light elements responsible for the parking lights or running lights are constantly on and are powered by control unit.

When using such a bodyless vehicle as a bicycle and other vehicles not equipped with their own electrical signaling devices, alternative transmitter unit is used. The alternative transmitter unit is made as a device/remote control for manual data transmission. The alternative transmitter unit is fastened preferably on a vehicle steering wheel, but its holding or fastening in the user's hand or on equipment of the user is also possible. The alternative transmitter unit is powered by the vehicle or its own battery or replaceable batteries.

For the children the system includes control unit which is equipped with an electronic chip having programmed options for glowing the light indication elements, and via the electronic chip the light indication elements can be controlled. In children's application, a remote control (31) is connected to the control unit.

Control unit, display unit and the light indication elements of the signaling system mounted on the equipment the user, a backpack or on equipment of the vehicle elements (wing, luggage rack, etc.) (installed anywhere at the request of the user) are switched by the user to the ON position by using the remote button of the signaling system, and the remote button is also used to select the operational mode of the signaling system.

Operational process of the system when the bodyless vehicle starts moving is as follows:

Light indication elements of signal system operate in the following several modes:

1. The parking/running lights and movement signals (stop signal, right and left turn signals).

2. The parking/running lights in a constant lighting mode

3. The parking/running lights in a flickering mode

The operational modes of the light indication elements of the signaling system are selected by means of switching via the remote control (31) in control unit (6).

The light elements of signaling system for children may be made in any form, using children's symbols, animals or heroes of children's fairy tales, movies, etc. In the signaling system for children in the control unit there is installed an electronic chip with programmed options for glowing the light elements, with the electronic chip being configured to control the light elements. When using the child signaling system for example for sport events, only the Control unit (Unit 2) is used. Now the Unit 2 works according to a simplified system, without a system for transmitting and receiving radio signals. The user switches Unit 2 to the ON position by using the remote button of the set, with the remote button being also configured to select the operational mode of the signaling system.

Next, the user starts using the signaling system at his/her discretion.

The same operational principle is applied in the road transport signaling system for worker of special services (such as traffic police, road workers, builders, railway workers, miners among others). In this case, the same light indication elements of signal system are not made in the children's stylistics, and the signal system uses different programming for providing the light signals—for each special service these programs are written individually.

All connecting cables, adapters, control buttons and housings of all units are coated with moisture-resistant protective materials.

### THE LIST OF REFERENCES

Ref 1—vehicle equipped with light signals
Ref 2—vehicle not equipped with light signals
Ref 3—vehicle lighting devices
Ref 4—Unit 1 a.k.a transmitter unit
Ref 5—Unit 1.2 a.k.a. alternative transmitter unit
Ref 6—Unit 2 a.k.a control unit
Ref 7—Unit 3 a.k.a display unit
Ref 8—light-emitting elements
Ref 9—shapes and types of the light-emitting elements
Ref 10—a GPS geological Unit
Ref 11—a right turn signal of the vehicle
Ref 12—a left turn signal of the vehicle
Ref 13—a stop signal of the vehicle
Ref 14—ground (electrical grounding)
Ref 15—power 12 V+
Ref 16—a connection line for left-turn indicators
Ref 17—a connection line for right-turn indicators
Ref 18—a connection line for the stop signal
Ref 19—a connection line for parking and running lights
Ref 20—a connection line for neon lights
Ref 21—a Unit 1-to-Unit 2 connection line
Ref 22—wireless data transmission
Ref 23—wired data transmission
Ref 24—a power supply/battery
Ref 25—a light signal relay
Ref 26—equipment items
Ref 27—a display of Unit 3
Ref 28—a lighting sensor
Ref 29—a collision sensor
Ref 30—a connection line for the signal lights (children's equipment and worker's special-service equipment)
Ref 31—a remote control button

What is claimed is:

1. An adjustable assembly for road transport signalling system comprising:
a transmitter unit, an alternative transmitter unit, a control unit, a display unit and a set of light indication elements; wherein
the transmitter unit comprises a transmitter for short-range data transmission, an individual code hardware-written in a device circuit, electronic or analog filters and an electrical surge and interference protection system, and the transmitter unit is configured to be connectable with the control unit and operable at same radio frequency as the control unit; and the transmitter unit is configured to be installed in an electrical light signalling system of a bodyless vehicle;
the alternative transmitter unit is a button-, voice- or touch-controlled device comprising a transmitter for short-range data transmission and a device for remote manual control, and the alternative transmitter unit is configured to be connectable with the control unit and operable at same radio frequency as the control unit;
the control unit comprises a receiving device for short-range data transmission, an individual code hardware-written in a device circuit, a battery compartment, a battery charging system, an electron control device/chip, a corrector for current control, an electronic device configured for radio signal binding with a unique code outgoing from/belonging to the transmitter unit;
the display unit comprises a collision sensor, a GPS tag, a display for indicating power level of control unit, and the display unit is configured to be connectable with the control unit; and
the set of light indication elements is connected to the control unit and attachable to a bodyless vehicle elements, to equipment or clothing of a user of the bodyless vehicle, or to clothing of a person, and which light indication elements are controlled by the control to synchronously repeat light signals of the bodyless vehicles;
wherein the units of the adjustable assembly are selectable based on the desired use, such that control unit, transmitter unit and display unit are required when the assembly is adjusted for use with bodyless vehicles that have their own electronic signalling system, control unit and alternative transmitter unit is required when the assembly is adjusted for use with bodyless vehicles that do not have their own electronic signalling system, and only control unit is required when the assembly is adjusted for children clothing or devices used by children.

2. The system of claim 1, wherein the light indication elements are selected from right turn signals, stop signal, parking lights and running lights, flexible neon light, and wherein the light indication elements are equipped with fasteners for mounting/fastening and dismounting.

3. The system of claim 1, wherein the GPS tag is configured to transmit an SOS signal to phone number predetermined by the user.

4. The system of claim 1, wherein the display unit comprises an emergency collision/rollover/fall sensor, which is configured to be triggered by a force or impact and/or by removal of a safety pin attached to a steering wheel of the bodyless vehicle and on wrist of the user; wherein triggering of the sensor causes the control unit to turn on the light indication elements to a bright SOS emergency stop signal.

5. The system of claim 4, wherein the control unit is configured to turn off power in engine of the vehicle when the emergency sensor is triggered.

6. A method of operating a road transport signalling system to enhance safety for users of bodyless vehicles, comprising:
providing an adjustable assembly comprising a transmitter unit, an alternative transmitter unit, a control unit, a display unit and a set of light indication elements;
wherein
in case of the bodyless vehicle has its own electronic signalling system selecting the control unit, the transmitter unit and the display unit for use, and the method comprises:
supplying power to an input of a transmission line consisting the transmitter unit and a receiver in the control unit when turning on an ignition of the bodyless vehicle and automatically triggering on the system, whereby a current state signal of signal lights of the bodyless vehicle is fed from an electric/electronic circuit of the bodyless vehicle and the signal is transmitted to the control unit for turning on light signalling elements, and wherein according to the incoming signals of the bodyless vehicle, the control units synchronously turns on, and off or corresponding light signaling elements of the system or changes a brightness of corresponding light elements, and wherein the light elements responsible for parking/running lights being constantly on and powered by the control unit;
in case the bodyless vehicle that does not have its own electronic signalling system selecting transmitter unit and display unit for use, and wherein the alternative transmitter unit is powered by a battery and functions as a remote control for manual data transmission; and
in case of devices used by children selecting only the control unit for use wherein the control unit is equipped with an electronic chip having programmed options for glowing the light indication elements and remotely control the system via a remote control connected to the control unit.

7. The method of claim 6, wherein the display unit comprises an emergency collision/rollover/fall sensor, which is configured to be triggered by a force or impact and/or by removal of a safety pin attached to a steering wheel of the bodyless vehicle and on wrist of the user; wherein triggering of the sensor causes the control unit to turn on the light indication elements to a bright SOS emergency stop signal.
